(19) United States
(12) Patent Application Publication
(10) Pub. No.: US 2005/0188515 A1
(43) Pub. Date: Sep. 1, 2005

(54) Louver retainer and method of use

(75) Inventors: Joseph E. Reimer, Oregon, WI (US); Shawn Drager, Prairie Du Sac, WI (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Springs Window Fashions LP, Fort Mill, SC (US)

(21) Appl. No.: 10/856,720

(22) Filed: May 28, 2004

Related U.S. Application Data
(63) Continuation-in-part of application No. 10/788,168, filed on Feb. 26, 2004.

(51) Int. Cl. B26D 7/02

(52) U.S. Cl. 29/24.5; 83/452

(57) ABSTRACT

A louver retainer for bundling blind slats to be trimmed by a cutdown machine and a method of bundling blind slats to be trimmed by a cutdown machine are disclosed. The slats in the louver retainer are sufficiently loose such that their edges can be lined up for trimming.

### CROSS REFERENCE TO RELATED APPLICATIONS

This application is a continuation-in-part application of U.S. patent application Ser. No. 10/788,168, filed Feb. 26, 2004.

### BACKGROUND OF THE INVENTION

The present invention relates to window blinds and other window coverings that are trimmed at the time of purchase at retail stores. More particularly, the present invention relates to a retainer for bundling louvers (or slats) to simplify and expedite the trimming of blinds at retail stores.

Over the past several years, different approaches have evolved with regard to preparing window blinds and other window coverings such that they have the dimensions needed to cover a particular window for a particular customer. One approach, which has long existed, involves the initial measuring of a window by an installer or decorator in order to determine the appropriate dimensions of the blind. This is followed by an order placed with the manufacturer (or an authorized fabricator), wherein the blind is then built to the particular specifications of the customer's window. The blind is then shipped and eventually installed. While the foregoing procedure normally provides satisfactory results in terms of the customer ultimately obtaining a blind that appropriately fits his or her window, there is an obvious disadvantage to this procedure, namely, the time associated with each of the foregoing steps, whereby it could take one or even several weeks from beginning to end.

Another approach that has been employed involves manufacturing and supplying retail stores with blinds having a number of “stock” sizes. Each blind is provided in a variety of such “stock” sizes, such that the customer can select a blind size that most closely approximates the size of the window to be covered. The drawbacks to this approach have long been self-evident. If a small number of stock sizes are provided, the likelihood of a customer finding a stock size that appropriately fits the customer's window is necessarily reduced. While this problem can be mitigated by providing more and different stock sizes, this necessarily results in the need for retailers to take on greater inventory and provide more shelf space for the blinds in question. These problems are exacerbated by the fact that blinds are typically offered in different colors and styles, and if it is necessary to stock numerous sizes of each color and style, the inventory and shelf space problems will increase accordingly.

A solution to the foregoing problems has led to what is now a popular approach to selling blinds and other window coverings. Under this approach, sometimes referred to as the “size-in-store” system, a relatively small number of stock sizes of each blind is provided to the retail store. The blinds themselves are designed in a manner that the headrails, slats (or other window coverings) and bottom rails can be trimmed at either (or preferably both) ends. This is accomplished by such stock blinds having lifting, tilting and similar mechanisms and cords positioned inwardly from the outer edges of the window coverings, such that the ends can be trimmed to the degree desired without impairing the operation of the window covering.

Such “size-in-store” systems also involve the retail store being provided with a cutdown machine designed to cut the particular blinds or other window coverings. One such cutdown machine is illustrated by U.S. Pat. No. 6,178,857, which is incorporated herein by reference.

While many different types of cutdown machines exist, certain characteristics are common to many if not most such machines. First, they will typically make provision for cutting the headrail, the slats (or other window covering material) and bottom rail of the window covering in question. In certain situations, such as illustrated in the aforementioned U.S. Pat. No. 6,178,857, different approaches and tools are used to cut the headrail, the slats and/or the bottom rail. In some such environments, the three aforesaid major components of a blind must be positioned in different areas of the cutdown machine. Finally, in order for a trimmed window covering to have an attractive finished look, the amount that is cut from each component must be the same to the extent possible, such that it is typically necessary to make certain that all components are lined up appropriately.

This particular problem is especially pronounced in connection with horizontal or a Venetian blind, which will typically have dozens of slats. When trimming the ends of a horizontal blind, it is essential that all of the slats be lined up evenly so that equal amounts of material can be trimmed from each slat.

When trimming slats of a horizontal blind, difficulties often arise when too many slats are bundled together to be trimmed in a single pass by one knife or other cutting device. Accordingly, in some cutdown machines and systems, the slats must be divided into compartments, each accommodating a predetermined number of slats (and, in some instances, a bottom rail that can be cut with the same cutting tool as the slats). It may be necessary for the individual doing the trimming to count up the correct number of slats to go in each compartment just prior to cutting.

In addition, the amount of time spent in trimming blinds will have a bearing on how well the cutdown program will be accepted by retail stores and the consumer. In existing programs, it can take time to organize the components and line them up prior to trimming, particularly if the cord lock becomes disengaged. Once the trimming is completed, it is desirable to repackage the blind as quickly as possible—an objective that can be hard to achieve if the blind is completely disorganized.

The foregoing problems and concerns are particularly pronounced in the environment of a retail store, such as a home improvement store. In those situations, the responsibility for trimming blinds will often rest on a sales associate who will typically be hired with no background or experience in trimming blinds. While training may be offered by the retail store or by the blind supplier, with regard to trimming blinds (as with any other endeavor) there is a learning curve. Moreover, it is not uncommon for retail stores to have turnover in staff, such that sales associates may be asked to trim blinds with little or no training or experience. When mistakes are made in trimming blinds, it is often necessary to discard a blind and start over, thus impacting on the profitability of the program.

Attempts have been made in the past to “bundle” slats together for compressing them and lining them up so they can be trimmed. One makeshift approach has been to take a conventional rubber band and wrap the rubber band around a handful of adjacent slats. However, the prospect of this approach having a satisfactory result is small. First, since compartments in cutdown machines are designed to optimally receive a specific number of slats, it is essential that the sales associate (or whoever is applying the rubber band) count the appropriate number of slats to be enclosed in a rubber band. Moreover, rubber bands are typically available only in standard sizes. Thus, the odds are high that a rubber band (whether in a single loop, or doubled or tripled over) will prove to be too loose or too tight. If the rubber band is too loose, it will serve little purpose in terms of keeping the slats together. If the rubber band is too tight, it will become difficult to line up the slats evenly with each other just prior to insertion into the cutdown machine.

Accordingly, a need has arisen for a system in which one or more of these problems faced by sales associates at retail stores can be obviated. Thus, there is a need to provide sales associates with a system in which they need not concern themselves with bundling the correct number of louvers to be inserted together into the cutdown machine. In addition, it would be desirable to provide a system that facilitates the trimming of louvers in a cutdown machine in a manner that maintains a preselected number of louvers together in the desired proximity, while providing the louvers with sufficient slack as to allow them to be lined up evenly with each other prior to insertion into the cutdown machine.

### SUMMARY OF THE INVENTION

One aspect of the present invention provides a retainer for holding a preselected number of blind slats in a stack for trimming, in which each of the slats has a preselected width and the stack has a preselected height, such that the preselected width and height define a preselected perimeter. A retainer according to one embodiment of the present invention comprises a clip having a first enclosure sized to accommodate the stack. The clip has first and second ends and an overall length substantially equal to the preselected perimeter of the stack of slats. The first and second ends of the enclosure are releasably attachable to each other.

A further aspect of the present invention comprises a retainer, for example, a clip, for holding a preselected number of blind slats in a stack for trimming, in which each of the sides has a preselected width, and the stack has a preselected height, such that the preselected width and height define a preselected perimeter. According to one or more embodiments, the clip comprises first and second enclosures. Each of the first and second enclosures is sized to accommodate the stack and has an overall length substantially equal to the preselected perimeter.

A further aspect of the present invention is directed to an assembly which comprises a plurality of window blind slats, each of the slats having a preselected width and the stack having a preselected height, with the preselected width and height defining a preselected perimeter. According to one or more embodiments, a retainer, for example, a clip, comprising a first enclosure is sized to accommodate and surrounds the stack and has first and second ends and an overall length substantially equal to the preselected perimeter of the stack. The first and second ends of the first enclosure are releasably attachable to each other.

Other embodiments of the present invention are directed to methods of producing and trimming a window blind which comprises supplying a blind having a plurality of slats, at least a pair of tilt ladders, each of the slats having a predetermined width. A preselected number of such slats are bundled. A retainer, such as a clip or other suitable structure is applied to the bundle of slats. The retainer could include a sheet of material having two ends, and the two ends can be fastened together. According to certain embodiments, the retainer could include a pair of spacer elements, such as blocks, the spacer elements being adapted to sandwich the bundle of slats therebetween. In preferred embodiments, the clip has two ends defining an opening such that the clip can be applied between the tilt ladders of the blind. In other embodiments, the clip is releasable. The bundle of slats is inserted into an opening in a cutdown machine, and the cutdown machine is operated to trim the slats in the bundle. The bundle is withdrawn from the cutdown machine, and the clip is detached from the bundle of slats.

### BRIEF DESCRIPTION OF THE DRAWINGS

A more complete appreciation of the subject matter of the present invention and the various advantages thereof can be realized by reference to the following detailed description in which reference is made to the accompanying drawings in which:

FIG. 1 is an illustration of a cutdown machine of the type with which the present invention can be used advantageously, illustrating the division of blind slats in separate compartments;

FIG. 2 is a perspective view of an embodiment of a louver retainer in the form of a clip according to the present invention;

FIG. 3 is a perspective view of a window blind with an embodiment of the louver clip of the present invention mounted to a plurality of slats;

FIG. 4 is a sectional view along the line 4-4 in FIG. 3 showing an embodiment of the present louver clip in its latched or closed condition;

FIG. 5 is a sectional view along the line 5-5 in FIG. 3 in which the louver clip is in an open position;

FIG. 6 is a perspective view of another embodiment of a louver retainer according to the present invention;

FIG. 7 is a perspective view of a window blind with an embodiment of the louver retainer of the present invention shown in FIG. 6 mounted to a plurality of slats;

FIG. 8 is a perspective view of another embodiment of a louver retainer according to the present invention; and

FIG. 9 is a perspective view of a window blind with an embodiment of the louver retainer of the present invention shown in FIG. 8 mounted to a plurality of slats.

### DETAILED DESCRIPTION

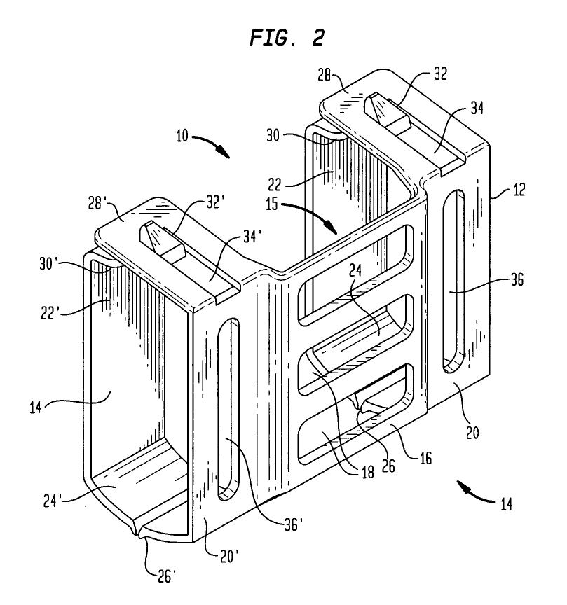

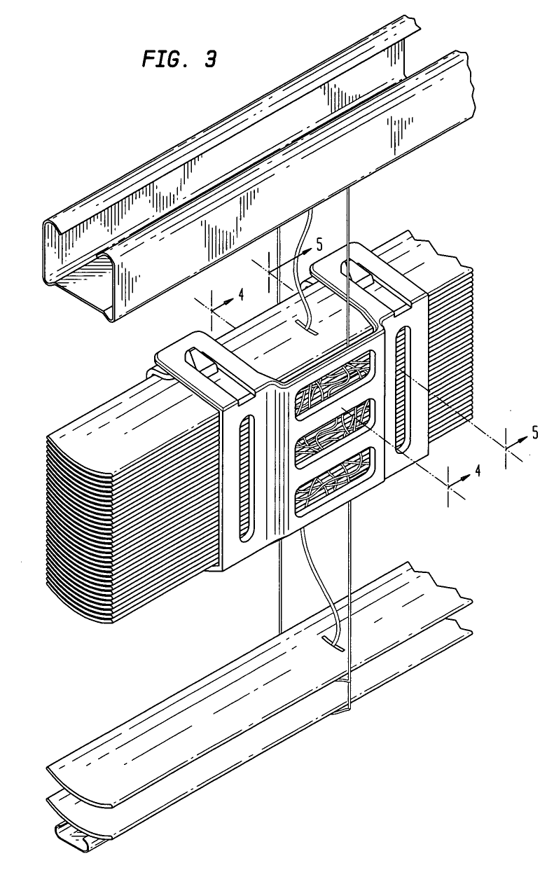

Referring now to the drawings, FIG. 2 shows an illustrative embodiment of a louver retainer of the present invention. Louver retainer in the form of a clip 10 includes first enclosure 12. First enclosure 12 includes a front wall 20 and a rear wall 22 which are connected to each other by bottom wall 24. Front wall 20 may optionally include opening 36, which allows slats to be viewed within first enclosure 12, and which reduces the amount of plastic needed. In this regard, it will be appreciated that the louver clip 10 can be employed such that the front wall 20 and rear wall 22 are mounted to a blind so that such walls are aligned with the front and rear of the blind, respectively; however, louver clip 10 can be mounted in the opposite fashion (i.e., front wall 20 is aligned with the rear of the blind). Likewise, the bottom wall 24 can be positioned at the bottom of louver clip 10; but it also can be reversed so that bottom wall 24 is on top. Thus, it will be understood that references herein to front and back or top and bottom are merely a convenient way to identify portions of the louver clip 10 that are on opposite sides from each other.

As seen in FIG. 2, while front wall 20 and rear wall 22 are preferably generally flat, bottom wall 24 is curved in a direction extending outwardly from first enclosure 12. The reason bottom wall 24 is curved is to accommodate the curvature on the slats of certain popular styles of blinds. It will be understood and appreciated that bottom wall 24 can also be flat rather than curved, and can be shaped to accommodate slats of any shape, such as S-shaped slats.

A hinge 26 is positioned at approximately the midpoint of the bottom wall 24. It will be appreciated by those skilled in the art that the hinge 26 can be placed in any number of different locations, so long as the hinge allows the first enclosure 12 to be moved between an open position and a closed position to allow the requisite number of slats to be inserted.

The louver clip 10 is preferably made of plastic material. The hinge 26 can consist of a “living hinge,” i.e., an area where the plastic material is thin or weakened. Alternatively, the hinge 26 can be provided in other forms known to those skilled in the art.

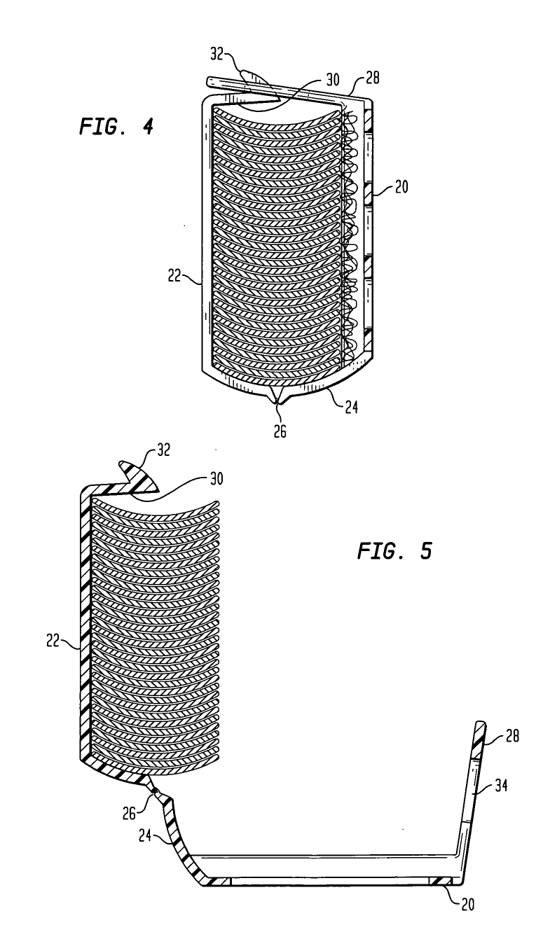

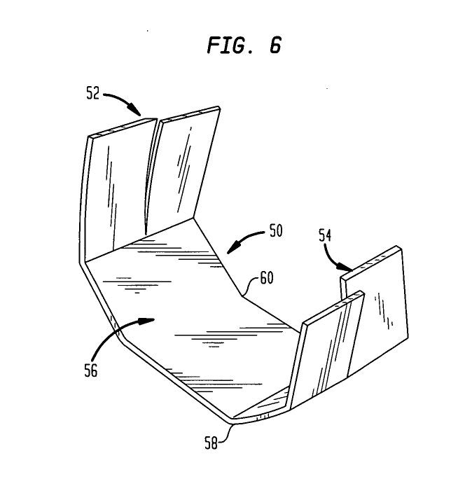

The first enclosure 12 also includes a front top wall part 28, which is attached to and preferably integral with front wall 20. As best seen in FIGS. 4 and 5, front top wall part 28 preferably tilts upward at a slight angle, such that the angle between front top wall part 28 and front wall 20 is slightly obtuse.

Attached to and preferably integral with rear wall 22 is rear top wall part 30. Rear top wall part 30 is preferably positioned at approximately a right angle with the rear wall 22 and points inwardly toward the front wall 20.

The front top wall part 28 includes a latch opening 34. Rear top wall part 30 includes a latch 32 mounted thereon. As can be most advantageously seen in FIGS. 2, 4 and 5, the latch opening 34 and the latch 32 are sized such that the latch 32 can releasably snap into latch opening 34 when the rear wall 22 is rotated toward the front wall 20 by means of hinge 26.

The front wall 20, rear wall 22, bottom wall 24, front top wall part 28 and rear top wall part 30 define the first enclosure 12. The first enclosure 12 thus has a width measured by the distance between front wall 20 and rear wall 22. That distance should be just slightly greater than the width of the slats of the blind with which the louver clip 10 is to be used.

Similarly, the bottom wall 24 and the front and rear top wall parts 28 and 30 define the height of first enclosure 12. It will be appreciated that, depending on the height of first enclosure 12, a predetermined number of slats from a blind which have been compressed together can be bundled into a stack within first enclosure 12. The width of first enclosure 12 (doubled) and the height of first enclosure 12 (doubled) define the perimeter of first enclosure 12.

Disregarding for the moment the portions of louver clip 10 other than the first enclosure 12, it will be appreciated that if the overall length of first enclosure 12 corresponds to the perimeter of a stack of slats, first enclosure 12 can be wrapped around that stack of blind slats and releasably locked so that movement of the slats is restrained. Because the spacing of front wall 20 and rear wall 22 is sized to be just slightly greater than the width of a blind slat, the slats will have little or no opportunity to slide laterally (i.e., forward or backward as seen in FIG. 2). The number of slats to be bundled in first enclosure 12 is a number which allows the slats within first enclosure 12 to fit snugly but still move longitudinally (i.e., left or right as seen in FIG. 2) without difficulty, such that the edges of the slats can be lined up for trimming.

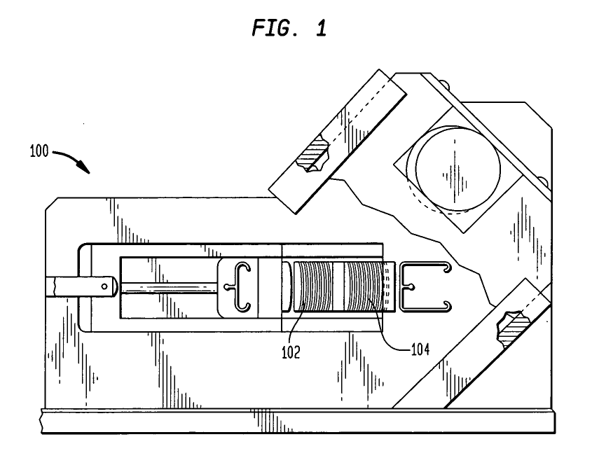

FIG. 1 illustrates a cutdown machine 100 of the type with which the present invention may be employed. It includes a plurality of compartments 102, 104 in which slats are positioned for trimming. It will be readily appreciated and understood that each particular cutdown machine which has compartments such as compartments 102, 104 will have a well-defined number of slats of a given type of blind that can be comfortably and optimally accommodated within such compartment. That is the number of slats that should preferably be bundled within first enclosure 12 of louver clip 10, and first enclosure 12 should be sized to accommodate that number of slats.

It will be appreciated by those skilled in the art that first enclosure 12 in and of itself (without the additional portions of louver clip 10 which will be discussed below) can and will hold the slats of a blind together for trimming. For example, the bundle of louvers will remain together even if the cord lock becomes disengaged. However, according to certain embodiments, additional advantages can be achieved by the additional portions of louver clip 10 that are shown in FIG. 2, which will now be described.

In particular, in addition to first enclosure 12, louver clip 10 includes second enclosure 14. In all material respects, second enclosure 14 will be substantially the same as first enclosure 12. That is, it includes a front wall 20′ with optional opening 36′, a rear wall 22′ and a bottom wall 24′ having a hinge 26′. It will also include a front top wall part 28′ with a latch opening 34′ connected to front wall 20′, and a rear top wall part 30′ including latch 32′ which engages with latch opening 34′. Each pair of corresponding walls of the first and second enclosures are preferably collinear with each other (e.g., rear walls 22 and 22′), as are hinges 26 and 26′.

First enclosure 12 and second enclosure 14 are connected to each other by central portion 15. All three components are preferably integral with each other. Central portion 15 includes an extended part 16, which extends outwardly from front walls 20 and 20′. As will become apparent shortly, a purpose of this is to accommodate the tilt ladders of the blind that tend to bunch up when the slats are compressed. The extended part 16 includes one or more openings 18. Such openings assist in providing a space for the bunched-up tilt ladders to occupy when the slats of a blind are compressed. In addition, openings 18 reduce the total amount of plastic material needed to manufacture louver clip 10, thus reducing the cost.

It will now be appreciated that the louver clip 10 can be mounted to a preselected number of slats in a blind, with that preselected number corresponding to the number of slats that can be accommodated in the cutting compartments of the cutdown machine to be used, such as compartments 102, 104 in cutdown machine 100 shown in FIG. 1. It will be appreciated that if the slats of the blind in question are curved in a downward direction as a blind is hung, the louver clip 10 can be mounted in the orientation shown in FIG. 2. On the other hand, if the slats are curved upward, louver clip 10 can simply be rotated 180° so that the curved bottom walls 24, 24′ are actually positioned at the top.

In mounting the louver clip 10 on a blind, care should be taken to position the first and second enclosures 12 and 14 so that they are on opposite sides of the lift cords and tilt ladders. This will result in the tilt ladder of the blind extending outward from the slats into the area defined by extended part 16 of central portion 15. As seen in FIG. 4, the additional space provided by the extended part 16 of the central portion 14 accommodates the tilt ladder, as may openings 18, which allow the bunched-up tilt ladder to extend therethrough.

It will be recalled that, as discussed above, a louver clip which includes only the first enclosure 12 and not the second enclosure 14 or the central portion 15 can be used according to one or more embodiments of the present invention. However, as discussed previously, the slats should be positioned in the first enclosure 12 such that the slats may slide about without great difficulty in a sideways direction as seen in FIG. 2, in order for the side edges of the slats to be lined up for counting. However, if a louver clip included only a first enclosure such as first enclosure 12, such first enclosure 12 would be somewhat free to slide about along the bundle of slats; and if the first enclosure 12 (again, by itself) was positioned on the outside of the tilt ladder and lift cords, it could slide off the blind altogether. An advantage of the retainers of the present invention is that they can be placed inside between the tilt ladders.

As will now be appreciated, in embodiments having first enclosure 12 and second enclosure 14 connected by central portion 15, by positioning first enclosure 12 and second enclosure 14 on opposite sides of the tilt ladder and lift cord, the louver clip 10 is substantially restrained from moving sideways by the tilt ladders and lift cord.

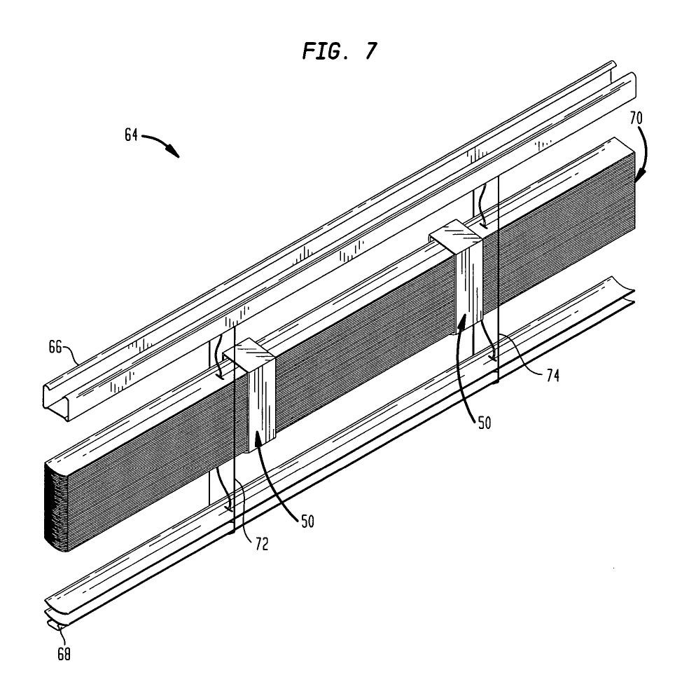

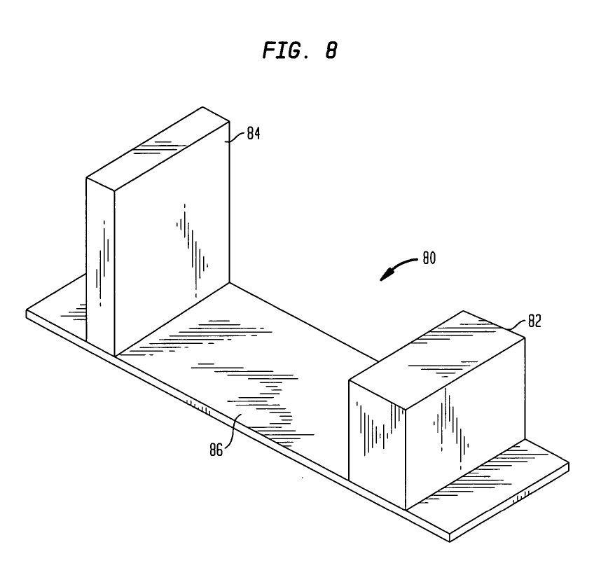

FIG. 6 shows another embodiment of a retainer, in which the retainer comprises a sheet of material 50 having two ends 52, 54 defining an enclosure 56 sized to surround and accommodate a stack of blind slats. The size of the enclosure 56 is predetermined based on the thickness of the slats, the width of the slats, and the number of slats in the stack. Preferably the sheet of material 50 is made from a flexible, inexpensive material such as paperboard. Other flexible, inexpensive materials such as plastic or cardboard could be used. Preferably, the sheet of material 50 includes creases 58, 60 at points corresponding to the width of the blind slats and the height of the stack. FIG. 7 shows a blind 64 including a head rail 66, a bottom rail 68, a stack of slats 70, and a pair of tilt ladders 72, 74 with two sheets of material 50 wrapped around the stack of slats. The two ends 52, 54 of the sheet of material 50 can be secured together by an adhesive. According to certain embodiments, tape can be used to secure the ends of the slats together. The sheets of material 50 maintain the stack of slats together and provide the slats with sufficient slack to allow them to be lined up evenly with each other prior to insertion into the cutdown machine. Advantageously, the sheets of material 50 can be inserted between the tilt ladders 72,74.

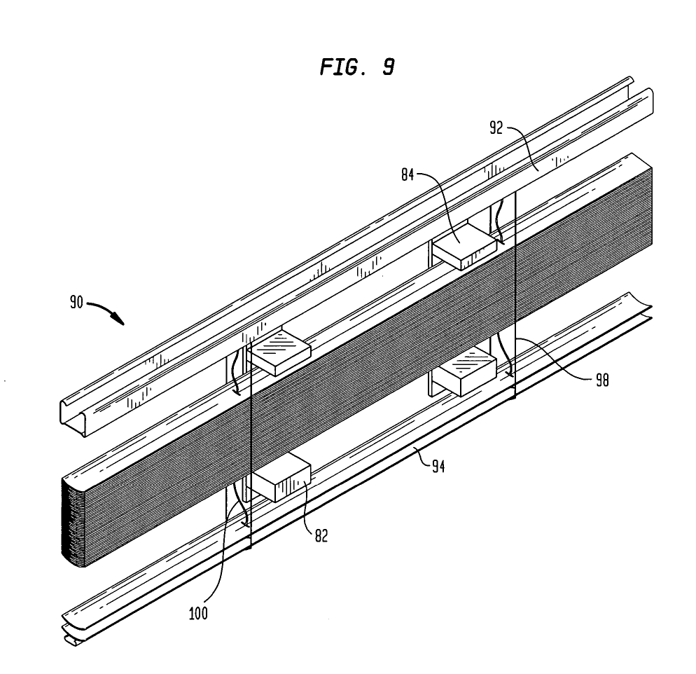

FIG. 8 shows another embodiment of a retainer 80, which comprises a pair of spacer elements 82, 84 in the form of blocks of material. The spacer elements 82, 84 can be the same size, or they can be different sizes. In the embodiment shown in FIG. 8, spacer element 84 is slightly taller than spacer element 82, as spacer element 84 is adapted to maintain spacing between the head rail of a blind and the stack of slats. The spacer elements are preferably mounted to a sheet or web of material at a distance sufficient to sandwich a stack of slats. In certain embodiments, the distance between the spacer elements 82, 84 is adjustable. While the embodiment shown in FIG. 8 includes only two such spacer elements, it will be understood by those skilled in the art, for certain types of cutting machines, it may be desirable to provide additional spacer elements. For example, an intermediate spacer element (not shown) may be provided between the spacer elements 82, 84. FIG. 9 shows a blind 90, including a head rail 92, a bottom rail 94, a stack of slats 96, and a pair of tilt ladders 98, 100 with the retainer 80 maintaining the stack of slats together and providing the slats with sufficient slack to allow them to be lined up evenly with each other prior to insertion into the cutdown machine. The assembly of the blind 90 and the retainer 80 can be further secured by wrapping material around the assembly at the point at which the retainer 80 is located along the length of the blind. For example, shrink wrap, tape, or plastic wrap can be wrapped around the entire assembly. In certain embodiments, the spacer element 82 is manufactured such that they maintain a predetermined spacing between the bottom rail and the stack of slats, and similarly, the spacer element 84 is manufactured such that they maintain a predetermined spacing between the head rail and the stack of slats

A louver retainer of the present invention such as louver clip shown in FIG. 2, or retainers of the type show in FIGS. 6 and 8 can be employed in a method of producing and trimming blinds, including programs where the trimming takes place at retail stores. Initially, the blind is produced or otherwise supplied. The blind will have slats having a predetermined width, which is selected to fit within the enclosures of the cutdown machine which is to be used with the blind. It is also necessary to determine a preselected number of slats that will be accommodated within the appropriate cutting compartment of the cutdown machine in question. This preselected number of slats is compressed or bundled together. A retainer, such as a releasable clip, open-ended retainer, or spacer element retainer of the type disclosed herein is applied to the bundle of slats. Depending on the height of the blind, it may be necessary to bundle a second of the preselected number of slats and apply a second retainer to that bundle, and so forth.

It will be appreciated that all of the steps just described can be done at the factory, and the blind can be placed into the package in which it will be shipped to the retail store with the retainer(s) of the present invention in place.

When a customer selects a blind at the retail store and wishes to have it trimmed, the sales associate or other operator can then remove the blind (including the retainer(s)) from the package. At this juncture, there is no need for the sales associate to count or bundle the appropriate number of slats for insertion into the cutdown machine, as that will have already been done for the sales associate. It will only be necessary to align the slats with each other (and with the headrail and bottom rail as may be required by the particular cutdown machine), which can be accomplished because the slats can move about longitudinally within the louver retainer. The associate can then insert the bundle of slats into the appropriate opening in the cutdown machine, after which the cutdown machine is operated to trim the bundle of slats, and the bundle is then withdrawn from the cutdown machine. As discussed above, the louver retainer expedites and simplifies the trimming process. At this juncture, the retainer will still be attached to the bundle of slats.

If desired, the louver retainer can be removed from the bundle of slats immediately after trimming and before repackaging the blind, in which event the blind is ready to be mounted as soon as the customer gets it home. If the louver retainer is removed at the retail store, it can be returned to the factory and reused with another blind. Alternatively, the louver retainer(s) can be left on the blind when it is repackaged, which will simplify the repackaging. In addition, some customers may find that mounting a blind is made somewhat easier by virtue of the louver retainer keeping the slats together during the mounting process. The customer can remove and discard the louver retainer, either before or after mounting the blind.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A retainer for holding in place for trimming a preselected number of blind slats formed into a stack, each of said slats having a preselected width and said stack having a preselected height, said preselected width and height defining a preselected perimeter, said retainer comprising a first enclosure sized to accommodate said stack and having first and second ends and an overall length substantially equal to said preselected perimeter, said first and second ends being releasably attachable to each other.

2. A retainer according to claim 1 wherein said first enclosure includes at least a front wall, a bottom wall connected to said front wall, and a rear wall connected to said bottom wall.

3. A retainer according to claim 2 wherein said front and rear walls define a space substantially equal to said preselected width.

4. A retainer according to claim 2 further comprising a hinge in one of said front wall, said bottom wall and said rear wall.

5. A retainer according to claim 2 wherein said bottom wall has a curved shape.

6. A retainer according to claim 5 wherein said curved shape extends outwardly from said enclosure.

7. A retainer according to claim 2 further comprising at least one top wall portion connected to said front wall or said rear wall.

8. A retainer according to claim 7 wherein said bottom wall and said at least one top wall portion define a space substantially equal to said preselected height.

9. A retainer according to claim 7 wherein said at least one top portion defines one of said first and second ends and includes a first latch member operable to releasably attach said first and second ends.

10. A retainer according to claim 9 wherein the other of said first and second ends includes a second latch member adapted to releasably engage said first latch member.

11. A retainer according to claim 1 further comprising a central portion connected to said first enclosure, and a second enclosure connected to said central portion, said second enclosure being sized to accommodate said stack and having first and second ends and an overall length substantially equal to said preselected perimeter, said first and second ends being releasably attachable to each other.

12. A retainer according to claim 11 wherein each of said first and second enclosures includes at least a front wall, a bottom wall connected to said first wall, and a rear wall connected to said bottom wall.

13. A retainer according to claim 12 wherein said central portion connects said front walls or said rear walls of said first and second enclosures.

14. A retainer according to claim 12 wherein said front, bottom and rear walls of said first enclosure are substantially collinear with said front, bottom and rear walls, respectively, of said second enclosure.

15. A retainer according to claim 12 further comprising a hinge in one of said front wall, bottom wall and rear wall of each of said first and second enclosures.

16. A retainer according to claim 15 wherein said hinges are substantially collinear.

17. A retainer according to claim 12 wherein said bottom wall of each of said first and second enclosures has a curved shape.

18. A retainer according to claim 17 wherein said curved shapes extend outwardly from said enclosures.

19. A retainer according to claim 12 further comprising at least one top wall portion connected to said front wall or said rear wall of each of said first and second enclosures.

20. A retainer according to claim 19 wherein said bottom wall and said at least one top wall portion in each of said first and second enclosures defines a space substantially equal to said preselected height.

21. A retainer according to claim 19 wherein said at least one top portion of each of said first and second enclosures defines one of said first ends and each said top portion includes a first latch member operable to releasably attach said first and second ends.

22. A retainer according to claim 21 wherein the other of said first and second ends of each of said first and second enclosures includes a second latch member adapted to releasably engage said first latch members.

23. A retainer according to claim 12 wherein at least part of said central portion extends outward from said front walls.

24. A retainer according to claim 23 further comprising at least one opening in said outwardly extending part.

25. A retainer for holding in place for trimming a preselected number of blind slats formed into a stack, each of said slats having a preselected width and said stack having a preselected height, said preselected width and height defining a preselected perimeter, said retainer comprising first and second enclosures, each of said first and second enclosures being sized to accommodate said stack and having an overall length substantially equal to said preselected perimeter.

26. A retainer according to claim 25 wherein each of said enclosures includes at least a front wall, a bottom wall connected to said front wall, and a rear wall connected to said bottom wall.

27. A retainer according to claim 26 wherein said front and rear walls in each of said enclosures defines a space substantially equal to said preselected width.

28. A retainer according to claim 26 further comprising hinges in one of said front walls, said bottom walls and said rear walls.

29. A retainer according to claim 26 wherein said bottom wall of at least one of said enclosures has a curved shape.

30. A retainer according to claim 26 wherein each of said first and second enclosures further comprises at least one top wall portion connected to said front wall or said rear wall.

31. A retainer according to claim 30 wherein said bottom wall and said at least one top wall portion define a space substantially equal to said preselected height.

32. A retainer according to claim 25 wherein each of said first and second enclosures comprises first and second ends.

33. A retainer according to claim 32 wherein said first and second ends in each of said enclosures are releasably attachable to each other.

34. A retainer according to claim 25 further comprising a central portion connecting said first and second enclosures.

35. A retainer according to claim 26 further comprising a central portion connecting said first and second enclosures.

36. A retainer according to claim 35 wherein said central portion connects said front walls or said rear walls of said first and second enclosures.

37. A retainer according to claim 26 wherein said front, bottom and rear walls of said first enclosure are substantially collinear with said front, bottom and rear walls, respectively, of said second enclosure.

38. A retainer according to claim 26 further comprising a hinge in one of said front wall, bottom wall and rear wall of each of said first and second enclosures.

39. A retainer according to claim 38 wherein said hinges are substantially collinear.

40. A retainer according to claim 35 wherein at least part of said central portion extends outward from said front walls.

41. A retainer according to claim 40 further comprising at least one opening in said outwardly extending part.

42. An assembly comprising:
(a) a plurality of window blind slats, each of said slats having a preselected width and said stack having a preselected height, said preselected width and height defining a preselected perimeter; and
(b) a retainer comprising a first enclosure sized to accommodate and surrounding said stack and having first and second ends and an overall length substantially equal to said preselected perimeter, said first and second ends being releasably attachable to each other.

43. An assembly according to claim 42 wherein said first enclosure includes at least a front wall, a bottom wall connected to said front wall, and a rear wall connected to said bottom wall.

44. An assembly according to claim 43 wherein said front and rear walls define a space substantially equal to said preselected width.

45. An assembly according to claim 43 further comprising a hinge in one of said front wall, said bottom wall and said rear wall.

46. An assembly according to claim 43 wherein said bottom wall has a curved shape.

47. An assembly according to claim 46 wherein said curved shape extends outwardly from said enclosure.

48. An assembly according to claim 43 further comprising at least one top wall portion connected to said front wall or said rear wall.

49. An assembly according to claim 48 wherein said bottom wall and said at least one top wall portion define a space substantially equal to said preselected height.

50. An assembly according to claim 48 wherein said at least one top portion defines one of said first and second ends and includes a first latch member operable to releasably attach said first and second ends.

51. An assembly according to claim 50 wherein the other of said first and second ends includes a second latch member adapted to releasably engage said first latch member.

52. An assembly according to claim 42 further comprising a central portion connected to said first enclosure, and a second enclosure connected to said central portion, said second enclosure being sized to accommodate and surrounding said stack and having first and second ends and an overall length substantially equal to said preselected perimeter, said first and second ends being releasably attachable to each other.

53. An assembly according to claim 52 wherein each of said first and second enclosures includes at least a front wall, a bottom wall connected to said first wall, and a rear wall connected to said bottom wall.

54. An assembly according to claim 53 wherein said central portion connects said front walls or said rear walls of said first and second enclosures.

55. An assembly according to claim 53 wherein said front, bottom and rear walls of said first enclosure are substantially collinear with said front, bottom and rear walls, respectively, of said second enclosure.

56. An assembly according to claim 53 further comprising a hinge in one of said front wall, bottom wall and rear wall of each of said first and second enclosures.

57. An assembly according to claim 56 wherein said hinges are substantially collinear.

58. An assembly according to claim 53 wherein said bottom wall of each of said first and second enclosures has a curved shape.

59. An assembly according to claim 58 wherein said curved shapes extend outwardly from said enclosures.

60. An assembly according to claim 53 further comprising at least one top wall portion connected to said front wall or said rear wall of each of said first and second enclosures.

61. An assembly according to claim 60 wherein said bottom wall and said at least one top wall portion in each of said first and second enclosures defines a space substantially equal to said preselected height.

62. An assembly according to claim 60 wherein said at least one top portion of each of said first and second enclosures defines one of said first ends and each said top portion includes a first latch member operable to releasably attach said first and second ends.

63. An assembly according to claim 62 wherein the other of said first and second ends of each of said first and second enclosures includes a second latch member adapted to releasably engage said first latch members.

64. An assembly according to claim 53 wherein at least part of said central portion extends outward from said front walls.

65. An assembly according to claim 64 wherein said retainer further comprises at least one opening in said outwardly extending part, and wherein said plurality of window blind slats further comprises a tilt ladder interspersed among said slats, and wherein portions of said tilt ladder are accommodated proximate said outwardly extending part.

66. An assembly according to claim 52 wherein said plurality of window blind slats further comprises a tilt ladder interspersed among said slats or a lift cord extending through said slats, and wherein said first and second enclosures are positioned on opposite sides of said tilt ladder or lift cord.

67. A method of producing and trimming a blind comprising:
(a) supplying a blind having a plurality of slats, each of said slats having a predetermined width;
(b) bundling a preselected number of said slats;
(c) applying a releasable retainer to said bundle of slats;
(d) inserting said bundle of slats into an opening in a cutdown machine;
(e) operating said cutdown machine to trim said slats in said bundle;
(f) withdrawing said bundle from said cutdown machine; and
(g) detaching said retainer from said bundle of slats.

68. A method according to claim 67 further comprising the step of packaging said blind after applying said releasable retainer.

69. A method according to claim 68 further comprising removing said blind from said package prior to said inserting step.

70. A method according to claim 69 further comprising repackaging said blind after said withdrawing step and before said detaching step.

71. A method according to claim 69 further comprising repackaging said blind after said detaching step.

72. A method according to claim 67 wherein said cutdown machine has at least one opening sized and shaped to accommodate said preselected number of slats having said preselected width.

73. A method according to claim 67 wherein said applying step allows said slats to move within said retainer.

74. A method according to claim 73 further comprising slidably aligning the slats within said retainer so that the ends of said slats are even prior to said operating step.

75. A method according to claim 67 wherein said retainer includes first and second enclosures connected by a central portion.

76. A method according to claim 75 wherein said blind includes at least one lift cord or tilt ladder, and wherein said application step comprises applying said retainer to said bundle of slats such that said first and second enclosures are positioned on opposite sides of said lift cord or tilt ladder.

77. A method according to claim 67 wherein said blind includes a bottom rail and wherein said bundling step includes bundling said bottom rail with at least one slat.

78. A method according to claim 67 further comprising the steps of applying a second releasable retainer to a second bundle of slats on said blind having said preselected number of said slats.

79. A method according to claim 67 wherein at least one of said inserting, operating and removing steps are performed at the place of purchase.

80. A method according to claim 67, wherein the blind includes a pair of tilt ladders, and the retainer is adapted to be placed between the pair of tilt ladders.

81. The method according to claim 80, wherein the retainer includes a sheet of material having two ends, the material adapted to be wrapped around the bundle of slats.

82. The method according to claim 81, further comprising securing the two ends of the sheet of material together.

83. The method according to claim 82, wherein the two ends are secured by an adhesive material.

84. The method according to claim 83, wherein the two ends are secured together by tape.

85. The method according to claim 80, wherein the retainer includes at least a pair of spacer elements spaced apart from each other and adapted to sandwich the bundle of slats.

86. The method according to claim 85, wherein at least one of the spacer elements separates the bundle of slats from the headrail of the blind by a predetermined distance.

87. The method according to claim 86, wherein the spacer elements are separated by a distance corresponding substantially the height of the bundle of slats.

88. A method according to claim 87 further comprising the step of packaging said blind after applying said releasable retainer.

89. A method according to claim 88 further comprising removing said blind from said package prior to said inserting step.

90. A method according to claim 89 further comprising repackaging said blind after said withdrawing step and before said detaching step.

91. A method according to claim 90 further comprising repackaging said blind after said detaching step.

92. A method according to claim 91 wherein said cutdown machine has at least one opening sized and shaped to accommodate said preselected number of slats having said preselected width.

93. A method according to claim 92 wherein said applying step allows said slats to move within said retainer.

94. A method according to claim 93 further comprising slidably aligning the slats within said retainer so that the ends of said slats are even prior to said operating step.

95. The method according to claim 87, wherein the spacer elements are mounted on a sheet of material.

96. The method according to claim 87, wherein the distance between the spacer elements is adjustable.

97. A retainer for holding in place for trimming a preselected number of blind slats formed into a stack on a cutdown machine, each of said slats having a preselected width and said stack having a preselected height, said preselected width and height defining a preselected perimeter, said retainer comprising an enclosure sized to accommodate said stack and having first and second ends and an overall length substantially equal to said preselected perimeter, said first and second ends being attachable to each other such that the retainer maintains the stack of slats together and provides the slats with sufficient slack to allow them to be lined up evenly with each other prior to insertion into the cutdown machine.

98. The retainer according to claim 97, wherein the enclosure comprises a flexible material.

99. The retainer according to claim 98, wherein the flexible material is paperboard.

100. The retainer according to claim 99, wherein the paperboard is creased at points corresponding to said preselected width of said slats and said preselected height of said slats.

101. An assembly comprising:
(a) a plurality of window blind slats, each of said slats having a preselected width and said stack having a preselected height, said preselected width and height defining a preselected perimeter; and
(b) a retainer comprising a first enclosure having two ends, the enclosure sized to accommodate and surrounding said stack and having first and second ends and an overall length substantially equal to said preselected perimeter, said two ends of said retainer being attachable to each other.

102. The assembly according to claim 101,wherein the retainer comprises a flexible material.

103. The assembly according to claim 102, wherein the flexible material is paperboard.

104. The assembly according to claim 103, wherein the paperboard is creased at points corresponding to said preselected width of said slats and said preselected height of said slats.

105. The assembly according to claim 104, wherein the two ends of the enclosure are secured together by an adhesive.

106. The assembly according to claim 105, wherein the two ends of the enclosure are secured together by tape.

107. The assembly according to claim 101, wherein the window blind includes a pair of ladders and the enclosure is adapted to be placed between the ladders.

108. An assembly comprising:
a plurality of window blind slats, each of said slats having a preselected width and said stack having a preselected height, said preselected width and height defining a preselected perimeter; and
(b) a retainer comprising a pair of spacer elements, the spacer elements spaced apart by a distance sufficient to sandwich said stack, maintain said stack of slats and provide the louvers with sufficient slack to allow them to be lined up evenly with each other prior to insertion into a cutdown machine.

109. The assembly according to claim 108, wherein the retainer further comprises a sheet of material to which the spacer elements are mounted.

110. The assembly according to claim 109, wherein the distance between the spacer elements is adjustable.

111. The assembly according to claim 107, wherein the plurality of slats is part of a window blind including a headrail and a pair of tilt ladders and one of the spacer elements maintains a predetermined spacing between the top of the bundle and the headrail of the blind.

112. The assembly according to claim 111, the retainer is adapted to be placed between the tilt ladders.
